(19) United States
(12) Patent Application Publication
(10) Pub. No.: US 2006/0101225 A1
(43) Pub. Date: May 11, 2006

(54) Method and system for a multi-stream tunneled marker-based protocol data unit aligned protocol

(76) Inventors: Eliezer Aloni, Zur Yigal (IL); Amil Oren, Palo Alto, CA (US); Caitlin Bestler, Laguna Hills, CA (US)

Correspondence Address: MCANDREWS HELD & MALLOY, LTD, 500 WEST MADISON STREET, SUITE 3400, CHICAGO, IL, 60661, US

(21) Appl. No.: 11/269,422

(22) Filed: Nov. 8, 2005

Related U.S. Application Data
(60) Provisional application No. 60/626,283, filed on Nov. 8, 2004.

(51) Int. Cl. G06F 12/10

(52) U.S. Cl. 711/202

(57) ABSTRACT

Aspects of a system for transporting information via a communications system may include a processor that enables establishing, from a local remote direct memory access (RDMA) enabled network interface card (RNIC), one or more communication channels, based on the transmission control protocol (TCP), between the local RNIC and at least one remote RNIC via at least one network. The processor may enable establishing at least one RDMA connection between one of a plurality of local RDMA endpoints and at least one remote RDMA endpoint utilizing the one or more communication channels. The processor may further enable communicating messages via the established RDMA connections between one of the plurality of local RDMA endpoints and at least one remote RDMA endpoint independent of whether the messages are in-sequence or out-of-sequence.

### CROSS-REFERENCE TO RELATED APPLICATIONS/INCORPORATION BY REFERENCE

This application makes reference to, claims priority to, and claims the benefit of U.S. Provisional Application Ser. No. 60/626,283 filed Nov. 8, 2004.

This application also makes reference to:

U.S. application Ser. No. ______ (Attorney Docket No. 17036US02) filed on even date herewith; and

U.S. application Ser. No. ______ (Attorney Docket No. 17098US02) filed on even date herewith

Each of the above stated applications is hereby incorporated herein by reference in its entirety.

### FIELD OF THE INVENTION

Certain embodiments of the invention relate to data communications. More specifically, certain embodiments of the invention relate to a method and system for a multi-stream tunneled marker-based protocol data unit (PDU) aligned (MST-MPA) protocol.

### BACKGROUND OF THE INVENTION

In conventional computing, a single computer system is often utilized to perform operations on data. The operations may be performed by a single processor, or central processing unit (CPU) within the computer. The operations performed on the data may include numerical calculations, or database access, for example. The CPU may perform the operations under the control of a stored program containing executable code. The code may include a series of instructions that may be executed by the CPU that cause the computer to perform specified operations on the data. The capability of a computer in performing operations may variously be measured in units of millions of instructions per second (MIPS), or millions of operations per second (MOPS).

Historically, increases in computer performance have depended on improvements in integrated circuit technology, often referred to as “Moore's law”. Moore's law postulates that the speed of integrated circuit devices may increase at a predictable, and approximately constant, rate over time. However, technology limitations may begin to limit the ability to maintain predictable speed improvements in integrated circuit devices.

Another approach to increasing computer performance implements changes in computer architecture. For example, the introduction of parallel processing may be utilized. In a parallel processing approach, computer systems may utilize a plurality of CPUs within a computer system that may work together to perform operations on data. Parallel processing computers may offer computing performance that may increase as the number of parallel processing CPUs in increased. The size and expense of parallel processing computer systems result in special purpose computer systems. This may limit the range of applications in which the systems may be feasibly or economically utilized.

An alternative to large parallel processing computer systems is cluster computing. In cluster computing a plurality of smaller computer, connected via a network, may work together to perform operations on data. Cluster computing systems may be implemented, for example, utilizing relatively low cost, general purpose, personal computers or servers. In a cluster computing environment, computers in the cluster may exchange information across a network similar to the way that parallel processing CPUs exchange information across an internal bus. Cluster computing systems may also scale to include networked supercomputers. The collaborative arrangement of computers working cooperatively to perform operations on data may be referred to as high performance computing (HPC).

Cluster computing offers the promise of systems with greatly increased computing performance relative to single processor computers by enabling a plurality of processors distributed across a network to work cooperatively to solve computationally intensive computing problems. One aspect of cooperation between computers may include the sharing of information among computers. Remote direct memory access (RDMA) is a method that enables a processor in a local computer to gain direct access to memory in a remote computer across the network. RDMA may provide improved information transfer performance when compared to traditional communications protocols. RDMA has been deployed in local area network (LAN) environments such as InfiniBand, Myrinet, and Quadrics. RDMA, when utilized in wide area network (WAN) and Internet environments, is referred to as RDMA over TCP, RDMA over IP, or RDMA over TCP/IP.

One of the problems attendant with some distributed cluster computing systems is that the frequent communications between distributed processors may impose a processing burden on the processors. The increase in processor utilization associated with the increasing processing burden may reduce the efficiency of the computing cluster for solving computing problems. The performance of cluster computing systems may be further compromised by bandwidth bottlenecks that may occur when sending and/or receiving data from processors distributed across the network.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for for a multi-stream tunneled marker-based protocol data unit (PDU) aligned (MST-MPA) protocol, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary distributed database processing environment, in connection with an embodiment of the invention.

FIG. 2 is an illustration of an exemplary conventional write operation from a local node to a remote node, in connection with an embodiment of the invention.

FIG. 3 is an illustration of an exemplary conventional write operation from a local node to a remote node, in connection with an embodiment of the invention.

FIG. 4 is an illustration of an exemplary conventional RDMA over TCP protocol stack, in connection with an embodiment of the invention.

FIG. 5 is an illustration of an exemplary RDMA over TCP protocol stack utilizing SCTP, in connection with an embodiment of the invention.

FIG. 6 is a block diagram of an exemplary system for an MST-MPA protocol, in accordance with an embodiment of the invention.

FIG. 7 is an illustration of an exemplary RDMA over TCP protocol stack utilizing MST-MPA, in accordance with an embodiment of the invention.

FIG. 8 is a block diagram illustrating an exemplary transfer of information between a local application and a local RDMA access point, in accordance with an embodiment of the invention.

FIG. 9 is a block diagram of an exemplary ULP PDU, in accordance with an embodiment of the invention.

FIG. 10 is a block diagram of an exemplary tunneling of information in an RDMA connection via a communication channel, in accordance with an embodiment of the invention.

FIG. 11 is a block diagram of an exemplary RDMA frame, in accordance with an embodiment of the invention.

FIG. 12 is a block diagram of an exemplary TCP packet, in accordance with an embodiment of the invention.

FIG. 13 is a block diagram illustrating an exemplary retrieval of an RDMA connection tunneled via a communication channel, in accordance with an embodiment of the invention.

FIG. 14 is a block diagram of an exemplary received MST-MPA protocol message, in accordance with an embodiment of the invention.

FIG. 15 is a block diagram illustrating an exemplary transfer of information between a remote RDMA access point and a remote application, in accordance with an embodiment of the invention.

FIG. 16 is a block diagram illustrating exemplary tunneling of RDMA connections within an RDMA connection, in accordance with an embodiment of the invention.

FIG. 17 is a flowchart illustrating exemplary steps for an MST-MPA protocol, in accordance with an embodiment of the invention.

FIG. 18 is a flowchart illustrating an exemplary process for buffer management at an RDMA endpoint, in accordance with an embodiment of the invention.

### DETAILED DESCRIPTION OF THE INVENTION

Certain embodiments of the invention may be found in a method and system for a multi-stream tunneled marker-based PDU aligned (MST-MPA) protocol. The invention may comprise a method and a system that may enable reliable communications between cooperating processors in a cluster computing environment while reducing the amount of processing burden in comparison to some conventional approaches to inter-processor communication among processors in the cluster.

Various aspect of the invention may provide an exemplary system for transporting information and may comprise a processor that enables establishment of TCP connections or channels between a local remote direct memory access (RDMA) enabled network interface card (RNIC) and at least one remote RNIC via at least one network. The processor may enable establishment at least one RDMA connection between one of a plurality of local RDMA endpoints and at least one remote RDMA endpoint utilizing the one or more communication channels. The processor may further enable communication of messages via the established RDMA connections between one of the plurality of local RDMA endpoints and at least one remote RDMA endpoint independent of whether the messages are in-sequence or out-of-sequence.

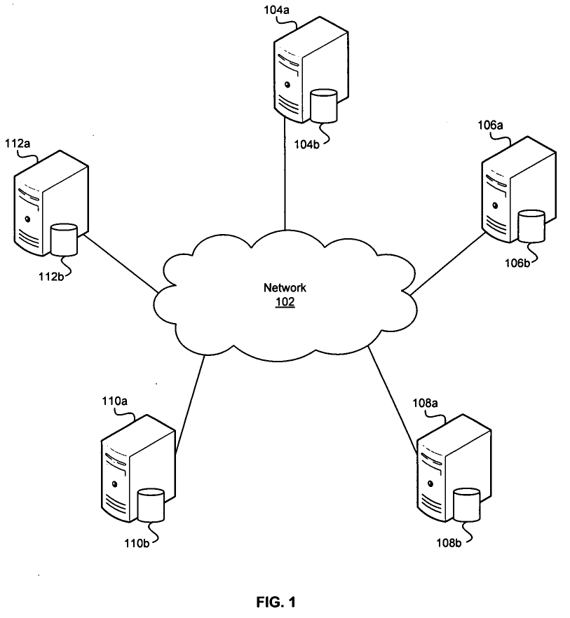

FIG. 1 illustrates an exemplary distributed database processing environment, in connection with an embodiment of the invention. Referring to FIG. 1, there is shown a network 102, a plurality of computer systems 104a, 106a, 108a, 110a, and 112a, and a corresponding plurality of database applications 104b, 106b, 108b, 110b, and 112b. The computer systems 104a, 106a, 108a, 110a, and 112a may be coupled to the network 102. One or more of the computer systems 104a, 106a, 108a, 110a, and 112a may execute a corresponding database application 104b, 106b, 108b, 110b, and 112b, respectively, for example. In general, a plurality of software processes, for example a database application, may be executing concurrently at a computer system.

In a distributed processing environment, such as in distributed database processing, for example, a database application, for example 104b, may communicate with one or more peer database applications, for example 106b, 108b, 110b, or 112b, via a network, for example, 102. The operation of the database application 104b may be considered to be coupled to the operation of one or more of the peer databases 106b, 108b, 110b, or 112b. A plurality of applications, for example database applications, which execute cooperatively, may form a cluster environment. A cluster environment may also be referred to as a cluster. The applications that execute cooperatively in the cluster environment may be referred to as cluster applications.

In some conventional cluster environments, a cluster application may communicate with a peer cluster application via a network by establishing a network connection between the cluster application and the peer application, exchanging information via the network connection, and subsequently terminating the connection at the end of the information exchange. An exemplary communications protocol that may be utilized to establish a network connection is the Transmission Control Protocol (TCP). An exemplary protocol that may be utilized to route information transported in a network connection across a network is the Internet Protocol (IP). An exemplary medium for transporting and routing information across a network is Ethernet, as defined by Institute of Electrical and Electronics Engineers (IEEE) resolution 802.3.

For example, database application 104b may establish a TCP connection to database application 110b. The database application 104b may initiate establishment of the TCP connection by sending a connection establishment request to the peer database application 110b. The connection establishment request may be routed from the computer system 104a, across the network 102, to the computer system 110a, via IP. The peer database application 110b may respond to the received connection establishment request by sending a connection establishment confirmation to the database application 104b. The connection establishment confirmation may be routed from the computer system 110a, across the network 102, to the computer system 104a, via IP.

After establishing the TCP connection, the database application 104b may issue a query to the database application 110b via the established TCP connection. In response to the query, the database application 110b may access data stored at computer system 110a. The database application 110b may subsequently send the accessed information to the database application 104b via the established TCP connection. The database application 104b may send an acknowledgement of receipt of the accessed data to the database application 110b via the established TCP connection. The database application 104b may terminate the established TCP connection by sending a connection terminate indication to the database application 119b.

In a cluster environment comprising N computer systems wherein P cluster applications, or software processes, are concurrently executing at each of the computer systems, the number of connections, NC, that may be established across a network at a given time instant may be:

$$NC = \frac{{P}^{2} N ( N - 1 )}{2} \qquad equation [ 1 ]$$

An exemplary cluster environment may comprise 8 computing systems, for example 104a, wherein 8 cluster applications, for example 104b, are executing at each of the 8 computer systems. In this exemplary regard, 1,712 connections may be established across a network, for example 102, at a given time instant.

Many of the connections established in some conventional cluster environments may be transient in nature. This may be true, for example, in transaction oriented cluster environments in which a cluster application may establish a connection when it needs to communicate with a peer cluster application across a network. At the completion of the communication, or transaction, the connection may be terminated. At a subsequent time instant, when the cluster application and peer cluster application need to communicate, the process of connection establishment, transaction, and connection termination may be repeated. The processing overhead required for maintaining large numbers of connections and/or frequent connection establishment and connection terminations may significantly decrease the processing efficiency of the cluster.

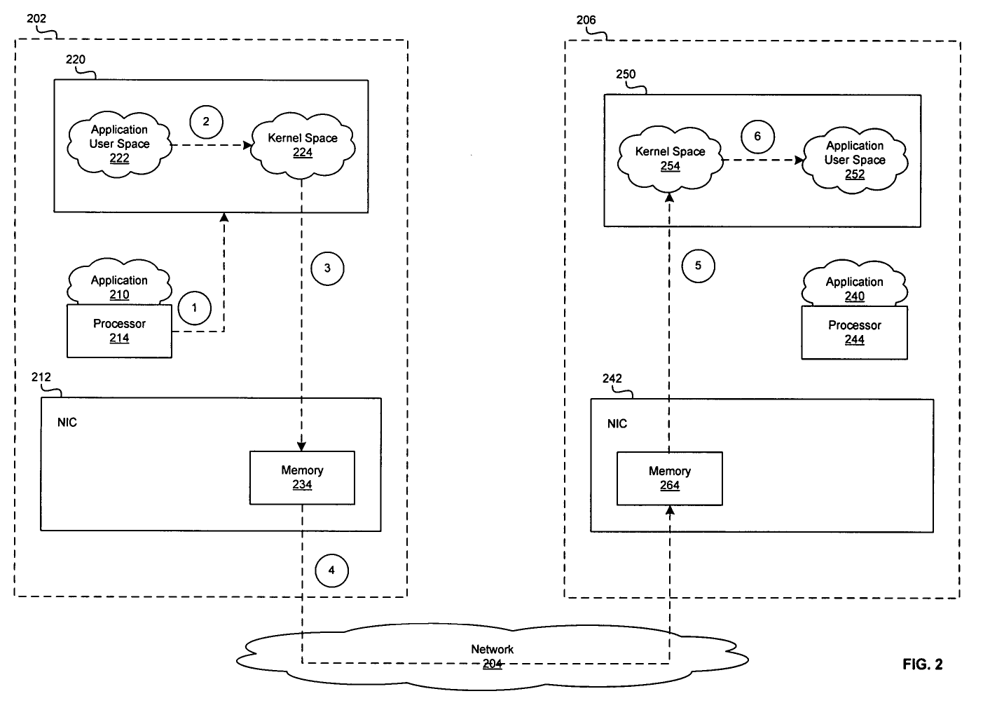

FIG. 2 is an illustration of an exemplary conventional write operation from a local node to a remote node, in connection with an embodiment of the invention. Referring to FIG. 2 there is shown a local node 202, a remote node 206, and a network 204. The local node 202 may comprise a system memory 220, a network interface card (NIC) 212, and a processor 214. Within in context of a cluster environment, a local computer system may be referred to as a local node while a remote computer system may be referred to as a remote node. The system memory 220 may comprise memory, which may store an application user space 222 and a kernel space 224. The processor 214 may execute an application 210. The NIC 212 may comprise a memory 234.

The remote node 206 may comprise a system memory 250, an NIC 242, and a processor 244. The system memory 250 may store an application user space 252 and a kernel space 254. The processor 244 may execute an application 240. The NIC 242 may comprise a memory 264.

The system memory 220 may comprise suitable logic, circuitry, and/or code that may be utilized to store, or write, and/or retrieve, or read, information, data, and/or executable code. The system memory 220 may comprise a plurality of memory technologies such as random access memory (RAM). The system memory 220 may be utilized to store and/or retrieve data that may be processed by the processor 214. The memory 220 may store a computer program or code that may be executed by the processor 214.

The application user space 222 may comprise a portion of information, and/or data that may be utilized by the application 210. The kernel space 224 may comprise a portion of information, data, and/or code associated with an operating system or other execution environment that provides services that may be utilized by the application 210. The processor 214 may comprise suitable logic, circuitry, and/or code that may be utilized to transmit, receive and/or process data. The processor 214 may execute an application 210, for example a database application. The application 210 may comprise at least one code section that may be executed by the processor 214.

The network interface chip/card (NIC) 212 may comprise suitable circuitry, logic and/or code that may transmit and/or receive data from a network, for example, an Ethernet network. The NIC 212 may be coupled to the network 204. The NIC 212 may process data received and/or transmitted via the network 204.

The system memory 250 may comprise suitable logic, circuitry, and/or code that may be utilized to store, or write, and/or retrieve, or read, information, data, and/or executable code. The system memory 250 may comprise different types of exemplary random access memory (RAM) such as DRAM and/or SRAM. The system memory 250 may be utilized to store and/or retrieve data that may be processed by the processor 244. The memory 250 may store a computer program or code that may be executed by the processor 244.

The application user space 252 may comprise a portion of information, and/or data that may be utilized by the application 240. The kernel space 254 may comprise a portion of information, data, and/or code associated with an operating system or other execution environment that provides services that may be utilized by the application 240. The processor 244 may comprise suitable logic, circuitry, and/or code that may be utilized to transmit, receive and/or process data. The processor 244 may execute an application 240, for example a database application. The application 240 may comprise at least one code section that may be executed by the processor 244. The NIC 242 may comprise suitable circuitry, logic and/or code that may enable transmission and reception of data from a network, for example, an Ethernet network. The NIC 242 may be coupled to the network 204. The NIC 242 may process data received and/or transmitted via the network 204.

In operation, the local node 202 may transfer data to the remote node 206 via the network 204. The data may comprise information that may be transferred from the application user space 222 in the local node 202 to the application user space 252 in the remote node 206. The application 210 may cause the processor 214 to issue instructions to the system memory 220 as illustrated in the segment 1 in FIG. 2. The instruction illustrated in segment 1 may cause information stored in the application user space 222 to be transferred to the kernel space 224 as illustrated in segment 2. The information may be subsequently transferred from the kernel space 224 to the NIC memory 234 as illustrated in segment 3. The NIC 212 may cause the information to be transferred from the memory 234 in the local node 202, via the network 204, to the memory 264 within the NIC 242 in the remote node 206 as illustrated in segment 4. The information may be transferred from the system memory 264 to the kernel space 254 within the system memory 250 in the remote node 206 as illustrated in segment 5. The information in the kernel space 254 may be transferred to the application user space 252 as illustrated in segment 6.

The remote direct memory access (RDMA) protocol may provide a more efficient method by which a database application, for example, executing at a local computer system may exchange information with a remote computer system across the network 102. For example, an RDMA based transfer of information may be accomplished without requiring the intervening step of transferring the information from application user space to kernel space as illustrated in FIG. 2.

The RDMA protocol may include two basic operations, an RDMA write operation, and an RDMA read operation. A third operation is read/write operation. The RDMA write operation may be utilized to transfer data from a local computer system to the remote computer system. The RDMA read operation may be utilized to retrieve data from a remote computer system that may subsequently be stored at the local computer system. For example, the database application 104b executing at a local computer system 104a may attempt to retrieve information stored at a remote computer system 110a. The database application 104b may issue the RDMA read instruction that may be sent across the network 102, and received by the remote computer system 110a. The requested information may subsequently be retrieved from the remote computer system 110a, transported across the network 102, and stored at the local computer system 104a.

The database application 104b executing at the local computer system 104a may attempt to transfer information to the remote computer system 110a by issuing an RDMA write instruction that may be sent from the local computer system 104a, across the network 102, and received by the remote computer system 110a. The database application 104b may subsequently cause the local computer system 104a to send information across the network 102 that is stored at the remote computer system 110a.

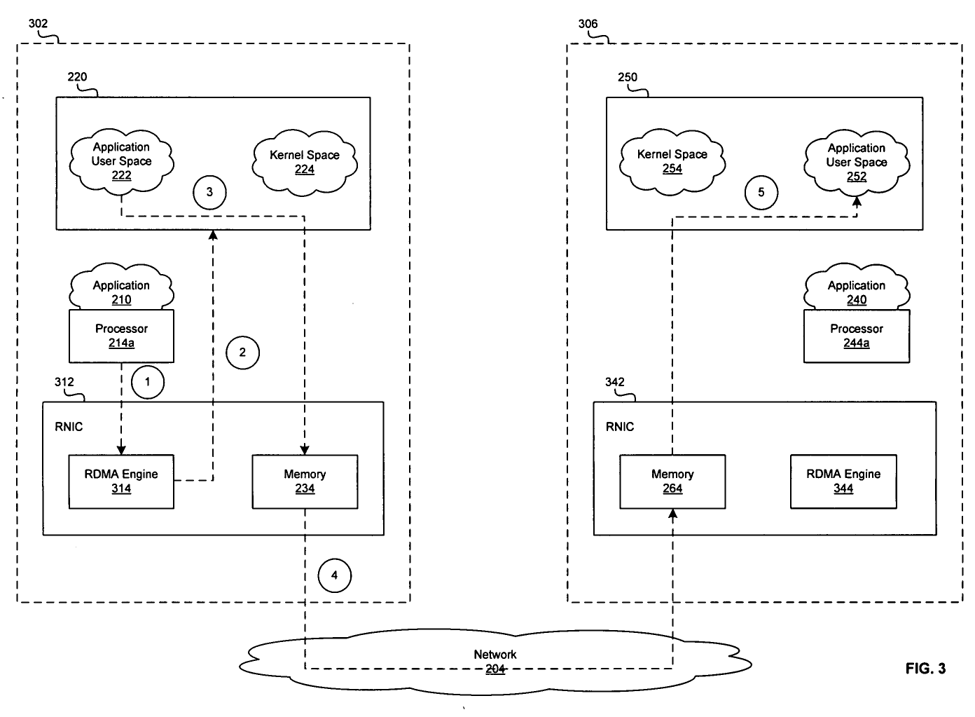

FIG. 3 is an illustration of an exemplary conventional write operation from a local node to a remote node, in connection with an embodiment of the invention. Referring to FIG. 3 there is shown a local node 302, a remote node 306, and a network 204. The local node 302 may comprise a system memory 220, an RDMA-enabled network interface card (RNIC) 312, and a processor 214. The system memory 220 may comprise an application user space 222 and a kernel space 224. The processor 214 may execute an application 210. The RNIC 312 may comprise an RDMA engine 314, and a memory 234.

The remote node 306 may comprise a system memory 250, an RNIC 342, and a processor 244. The RNIC 342 may comprise an RDMA engine 344 and a memory 264. The RNIC 312 may comprise suitable circuitry, logic and/or code that may enable transmission and reception of data from a network, for example, an Ethernet network. The RNIC 312 may be coupled to the network 204. The RNIC 312 may process data received and/or transmitted via the network 204.

The RDMA engine 314 may comprise suitable logic, circuitry, and/or code that may be utilized to send instructions to system memory 220 and/or memory 234 that may result in the transfer of information from the local node 302 to the remote node 306 via the network 204. The RDMA engine 314 may be programmed with a local memory address, a local node address, a remote memory address, a remote node address, and a length. The RDMA engine 314 may then cause a block of information of a size, length, starting at location, local memory address, within the system memory 220 of the local node 302, local node address, to be transferred via the network 204 to a location starting at location, remote memory address, within the system memory 250 of the remote node 306, remote node address.

The RNIC 342 may comprise suitable circuitry, logic and/or code that may transmit and receive data from a network, for example, an Ethernet network. The RNIC 342 may be coupled to the network 204. The RNIC 342 may process data received and/or transmitted via the network 204.

The RDMA engine 344 may comprise suitable logic, circuitry, and/or code that may be utilized to send instructions to system memory 250 and/or memory 264 that may result in the transfer of information from the remote node 306 to the local node 302 via the network 204 as described for the RDMA engine 314.

In operation, the local node 302 may transfer data to the remote node 306 via the network 204. The data may comprise information that may be transferred from the application user space 222 in the local node 202 to the application user space 252 in the remote node 206. The application 210 may cause the processor 214 to issue instructions to the RDMA engine 314 as illustrated in the segment 1 in FIG. 2. The instructions may comprise a local memory address, local node address, remote memory address, remote node address, and length. The instruction illustrated in segment 1 may cause the RDMA engine 314 to issue instructions to the system memory 220 as illustrated in segment 2. The instructions as illustrated in segment 2 may cause information stored in the application user space 222 to be transferred to the RNIC memory 234 as illustrated in segment 3. The RNIC 312 may cause the information to be transferred from the memory 234 in the local node 302, via the network 204, to the memory 264 within the RNIC 342 in the remote node 306 as illustrated in segment 4. The information may be transferred from the system memory 264 to the application user space 252 as illustrated in segment 5.

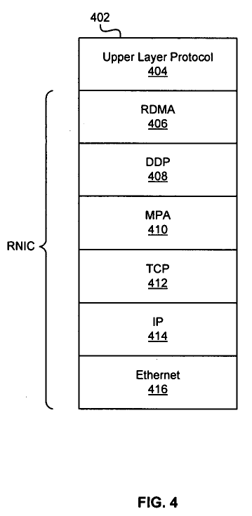

FIG. 4 is an illustration of an exemplary conventional RDMA over TCP protocol stack, in connection with an embodiment of the invention. Referring to FIG. 4, there is shown a conventional RDMA over TCP protocol stack 402. The RDMA over TCP protocol stack 402 may comprise an upper layer protocol 404, an RDMA protocol 406, a direct data placement protocol (DDP) 408, a marker-based PDU aligned protocol (MPA) 410, a TCP 412, an IP 414, and an Ethernet protocol 416. An RNIC may comprise functionality associated with the RDMA protocol 406, DDP 408, MPA protocol 410, TCP 412, IP 414, and Ethernet protocol 416.

The RDMA protocol specifies various methods that may enable a local computer system to exchange information with a remote computer system via a network 204. The methods may comprise an RDMA read operation and/or an RDMA write operation. The RDMA protocol may also comprise the establishment of an RDMA connection between the local computer system and the remote computer system prior to the exchange of information. An RDMA connection may be established by, for example, a local computer system that sends an RDMA connection request message to the remote computer system and, in response, the remote computer system that sends an RDMA response message to the local computer system. The local computer system and remote computer system may subsequently utilize the established RDMA connection to exchange information via the network 204. The exchange of information may comprise a local computer system that sends one or more sequence numbered frames to the remote computer system. The exchange of information may also comprise a remote computer system that sends one or more sequence numbered frames to the local computer system. The sequence numbers may indicate a relative ordering among frames. For example, the sequence number in a current frame may indicate, to the receiver of the frame, a relationship between the current frame and a preceding frame and/or subsequent frame.

The DDP 408 may enable copy of information from an application user space in a local computer system to an application user space in a remote computer system without performing an intermediate copy of the information to kernel space. This may be referred to as a “zero copy” model. The DDP 408 may embed information in each transmitted sequence numbered frame that enables information contained in the frame to be copied to the application user space in the remote computer system. This copy may be done regardless of whether a current sequence numbered frame is received in-sequence, or out-of-sequence, relative to a preceding sequence numbered frame, or subsequent sequence numbered frame, that is sent via the established RDMA connection.

The MPA protocol 410 may comprise methods that enable frames transmitted in an RDMA connection to be transported, via the network 204, via a TCP connection. The MPA protocol 410 may enable a single TCP connection to carry frames associated with a corresponding single RDMA connection. In the transmitting direction, the MPA protocol 410 may receive a sequence numbered frame associated with an RDMA connection. The MPA protocol 410 may derive information from the received RDMA frame to identify the corresponding RDMA connection. The MPA protocol 410 may determine the corresponding TCP connection associated with the RDMA connection. The MPA protocol 410 may utilize the sequence numbered frame from the RDMA connection to form a TCP packet. The formation of a TCP packet from the sequence numbered frame may be referred to as encapsulation, for example. The TCP packet may be transmitted, via the network 204, utilizing the corresponding TCP connection.

In the receiving direction, the MPA protocol 410 may receive a TCP packet associated with a TCP connection from the network 204. The MPA protocol 410 may derive information from the received TCP packet to determine the corresponding RDMA connection associated with the TCP connection. The MPA protocol 410 may extract an RDMA frame from the TCP packet. The extraction of an RDMA frame from the TCP packet may be referred to as de-encapsulation, for example. At least a portion of the information contained within the received RDMA frame, referred to as a payload, may be copied to the application user space.

The TCP 412, and IP 414 may comprise methods that enable information to be exchanged via a network according to applicable standards as defined by the Internet Engineering Task Force (IETF). The Ethernet 416 may comprise methods that enable information to be exchanged via a network according to applicable standards as defined by the IEEE.

In operation, the local node 302 may transfer data to the remote node 306 via the network 204. An upper layer protocol 404 may comprise an application 210 that issues an RDMA write request to write information from the application user space 222 to the application user space 254. The RDMA write request may cause the RDMA protocol 406 to establish an RDMA connection between the local node 302, and the remote node 306. The RDMA protocol 406 may send a connection request message to the remote computer system 306. In response, the MPA protocol 410 may request that the TCP 412 establish a TCP connection between the local node 302 and the remote node 306. Upon establishment of the TCP connection the MPA protocol 410 may encapsulate at least a portion of the RDMA connection request message in a TCP packet that may be sent to the remote node 306 via the established TCP connection. The MPA protocol 410 may subsequently receive a TCP packet containing the corresponding RDMA response message. The MPA protocol 410 may de-encapsulate the TCP packet and send at least a portion of the RDMA response message to the RDMA protocol 406. Accordingly, a TCP connection may be established between the local node 302 and the remote node 306. The TCP connection may be utilized by a corresponding RDMA connection to exchange information via the network 204.

An upper layer protocol 404 may be utilized to transfer information from the local node 302 in an RDMA frame to the remote node 306 via established the RDMA connection. At the completion of the information transfer from the local node 302 to the remote node 306, the RDMA connection may be terminated. Correspondingly, the TCP connection utilized in connection with the RDMA connection may also be terminated.

In a conventional RDMA over TCP implementation the number of RDMA connections may be equal to the number of TCP connections. Consequently, in a cluster environment, the total number of TCP and RDMA connection may be equal to twice the number of connections as indicated in equation[1].

The total number of connections may be reduced if a single TCP connection is utilized to transport information corresponding to a plurality of RDMA connections between the local node 302 and the remote node 306. In this case, the TCP connection may be utilized as a tunnel. One approach to TCP tunneling may utilize the stream control transport protocol (SCTP).

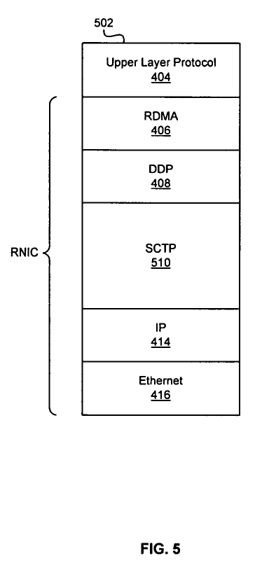

FIG. 5 is an illustration of an exemplary RDMA over TCP protocol stack utilizing SCTP, in connection with an embodiment of the invention. Referring to FIG. 5, there is shown a conventional RDMA over TCP protocol stack 502. The RDMA over TCP protocol stack 502 may comprise an upper layer protocol 404, an RDMA protocol 406, a direct data placement protocol 408, an SCTP 510, an IP 414, and an Ethernet protocol 416. An RNIC may comprise functionality associated with the RDMA protocol 406, DDP 408, SCTP 510, IP 414, and Ethernet protocol 416.

Aspects of the SCTP 510 may comprise functionality equivalent to the MPA protocol 410 and TCP 412. In addition, the SCTP 510 may allow a TCP connection to correspond to a plurality of RDMA connections. The SCTP 510 may comprise methods that enable frames transmitted in an RDMA connection to be transported, via the network, through an SCTP association. An SCTP association may comprise functionality comparable to a TCP connection. For the purposes of this application, an SCTP association may also be referred to as an SCTP connection. An SCTP connection, however, may incorporate additional functionality beyond a TCP connection that may enable the SCTP connection to be utilized as a tunnel. The SCTP 510 may enable a single SCTP connection to carry frames associated with a corresponding plurality of RDMA connections.

SCTP 510 may be utilized in the exemplary protocol stack 502 to reduce the total number of connections in a cluster environment in comparison to the exemplary protocol stack 402. One disadvantage in the utilization of SCTP 510 is that an RNIC may be required to store executable code that may comprise overlapping functionality. For example, a TCP 412 stack may typically be stored in an RNIC. To take advantage of the tunneling capability of SCTP 510, the RNIC may be required to store executable code for SCTP 510, including code that comprises functionality that substantially overlaps that of TCP 412. In addition, some intermediate nodes within the network 204, may be unable to process packets in an SCTP connection. For example, firewalls and/or port network address translation (PNAT) nodes may be unable to process packets transported in an SCTP connection.

Various embodiments of the invention may provide a method and a system for tunneling a plurality of RDMA connections within a TCP connection. In one aspect, this may enable greater reuse of existing protocol stacks stored in the RNIC while achieving the benefits of tunneling. Various embodiments of the invention may be utilized with existing network infrastructures that comprise firewall nodes, PNAT nodes, and/or devices that implement various security methods within the network 204.

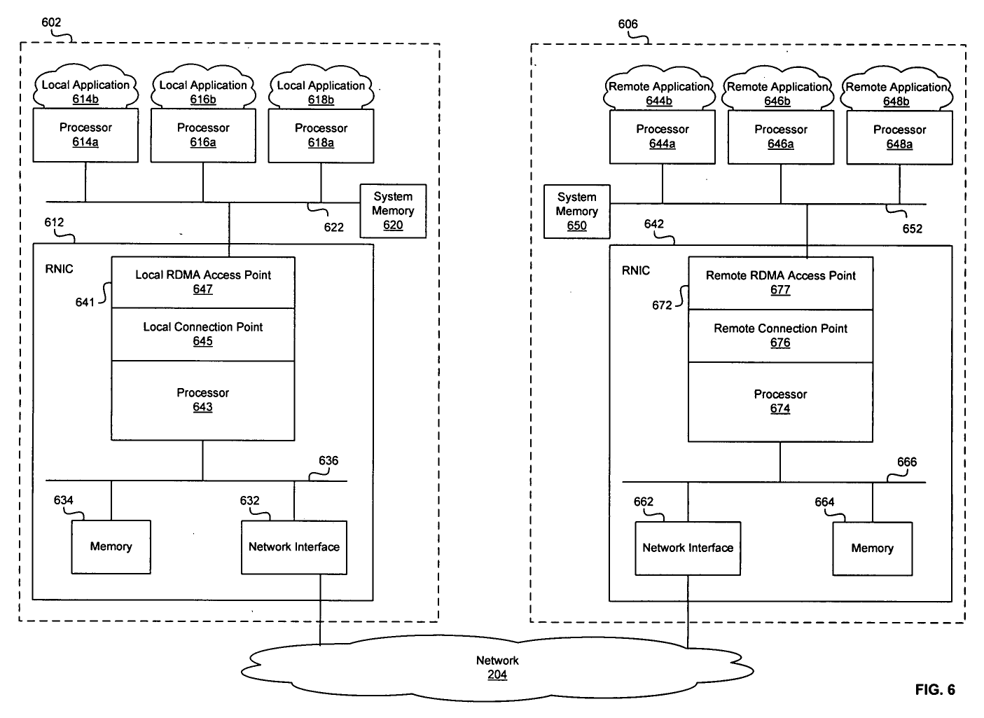

FIG. 6 is a block diagram of an exemplary system for an MST-MPA protocol, in accordance with an embodiment of the invention. Referring to FIG. 6, there is shown a network 204, and a local computer system 602, and a remote computer system 606. The local computer system 602 may comprise an RDMA-enabled network interface card (RNIC) 612, a plurality of processors 614a, 616a and 618a, a plurality of local applications 614b, 616b, and 618b, a system memory 620, and a bus 622. The RNIC 612 may comprise a TCP offload engine (TOE) 641, a memory 634, a network interface 632, and a bus 636. The TOE 641 may comprise a processor 643, a local connection point 645, and a local RDMA access point 647. The remote computer system 606 may comprise a RNIC 642, a plurality of processors 644a, 646a, and 648a, a plurality of remote applications 644b, 646b, and 648b, a system memory 650, and a bus 652. The RNIC 642 may comprise a TOE 672, a memory 664, a network interface 662, and a bus 666. The TOE 672 may comprise a processor 674, a remote connection point 676, and a remote RDMA access point.

The processor 614a may comprise suitable logic, circuitry, and/or code that may be utilized to transmit, receive and/or process data. The processor 614a may execute applications code, for example a database application. The processor 614a may be coupled to a bus 622. The processor 614a may perform protocol processing when transmitting and/or receiving data via the bus 622.

In the transmitting direction, the protocol processing performed by the processor 614a may comprise receiving data and/or instructions from an application 614b, for example. The data may comprise one or more upper layer protocol (ULP) protocol data units (PDU). The instructions may comprise instructions that cause the processor 614a to perform tasks related to the RDMA protocol. The instructions may result from function calls from an RDMA application programming interface (API). An instruction may cause the processor 614a to perform steps to initiate one or more RDMA connections.

In the receiving direction the protocol processing performed by the processor 614a may comprise receiving ULP PDUs via the bus 622 that were received via the NIC 612. The processor 614a may perform protocol processing on at least a portion of the ULP PDU received from the NIC 612, via the bus 622. At least a portion of the ULP PDU may be subsequently utilized by an application 614b, for example.

The local application 614b may comprise a computer program that comprises at least one code section that may be executable by the processor 614a for causing the processor 614a to perform steps comprising protocol processing, in accordance with an embodiment of the invention. The processor 616a may be substantially as described for the processor 614a. The local application 616b may be substantially as described for the local application 614b. The processor 618a may be substantially as described for the processor 614a. The local application 618b may be substantially as described for the local application 614b.

The system memory 620 may comprise suitable logic, circuitry, and/or code that may be utilized to store, or write, and/or retrieve, or read, information, data, and/or executable code. The system memory 620 may comprise a plurality of memory technologies such as random access memory (RAM). The system memory 620 may be utilized to store and/or retrieve data and/or PDUs that may be processed by one or more of the processors 614a, 616a, or 618a. The memory 620 may comprise code that may be executed by the one or more of the processors 614a, 616a, or 618a.

The RNIC 612 may comprise suitable circuitry, logic and/or code that may transmit and/or receive data from a network, for example, an Ethernet network. The functionality of the RNIC 612 may be contained in a single integrated circuit chip and/or a chipset. The RNIC 612 may be coupled to the network 604. The RNIC 612 may enable the local computer system 602 to utilize RDMA to exchange information with a peer computer system in a cluster environment. The RNIC 612 may process data received and/or transmitted via the network 204. The RNIC 612 may be coupled to the bus 622. The RNIC 612 may process data received and/or transmitted via the bus 622. In the transmitting direction, the RNIC 612 may receive data via the bus 622. The NIC 612 may process the data received via the bus 622 and transmit the processed data via the network 204. In the receiving direction, the RNIC 612 may receive data via the network 204. The RNIC 612 may process the data received via the network 204 and transmit the processed data via the bus 622.

The TOE 641 may comprise suitable logic, circuitry, and/or code to receive data via the bus 222 from one or more processors 614a, 614b, or 614c, and to perform protocol processing and to construct one or more packets and/or one or more frames. In the transmitting direction the TOE 641 may receive data via the bus 622. The TOE 641 may perform protocol processing that encapsulates at least a portion of the received data in a protocol data unit (PDU) that may be constructed in accordance with a protocol specification, for example, RDMA. The RDMA PDU may be referred to as a RDMA frame, or frame. The TOE 641 may also perform protocol processing that encapsulates at least a portion of the RDMA frame in a PDU that may be constructed in accordance with a protocol specification, for example, TCP. The TCP PDU may be referred to as a TCP packet, or packet. The portion of the RDMA frame may in turn be contained in one or more MST-MPA protocol messages. In addition to containing at least a portion of an RDMA frame, the MST-MPA protocol message may contain a frame length, source endpoint identifier, destination endpoint identifier, source sequence number, and/or error check fields. At least a portion of the MST-MPA protocol message may then be contained in a TCP packet. The TCP protocol processing may comprise constructing one or more PDU header fields comprising source and/or destination network addresses, source and/or destination port identifiers, and/or computation of error check fields. The packet may be transmitted via the bus 236 for subsequent transmission via the network 204. In various embodiments of the invention, the TOE 641 may associate a plurality of RDMA connections with a TCP connection. The TCP connection may be utilized as a tunnel that transports encapsulated RDMA frames, or portions thereof, in TCP packets across a network 204 via the TCP connection.

In the receiving direction the TOE 641 may receive PDUs via the bus 636 that were previously received via the network 204. The TOE 641 may perform TCP protocol processing that de-encapsulates at least a portion the PDU received from the network 204, via the bus 236 in accordance with a protocol specification, to extract one or more MST-MPA protocol messages. The TCP protocol processing may comprise verifying one or more PDU header fields comprising source and/or destination network addresses, source and/or destination port identifiers, and/or computations to detect and/or correct bit errors in the received PDU. The MST-MPA protocol processing may comprise verifying source and/or destination endpoint identifiers, source sequence numbers, and/or computations to detect and/or correct bit errors in the received MST-MPA protocol message. The RDMA frame may be delivered from one or more lower layer protocol PDUs, for example, one or more MST-MPA protocol messages. The TOE 641 may perform RDMA protocol processing that de-encapsulates at least a portion of the RDMA frame to extract data. The RDMA protocol processing may comprise verifying one or more frame header fields comprising frame length, source endpoint identifier, destination endpoint identifier, source sequence number and/or error check fields. The data may be subsequently processed by the TOE 641 any transmitted via the bus 622.

The TOE 641 may cause at least a portion of a PDU that was received via the bus 636 that was previously received via the network 204 to be stored in the memory 634. The TOE 641 may cause at least a portion of a PDU, which is to be subsequently transmitted via the network 204, to be stored in the memory 634. The TOE 641 may cause an intermediate result, comprising a PDU or data, which is processed at least in part by the TOE 641, to be stored in the memory 634.

The memory 634 may comprise suitable logic, circuitry, and/or code that may be utilized to store, or write, and/or retrieve, or read, information, data, and/or executable code. The memory 634 may comprise a random access memory (RAM) such as DRAM and/or SRAM. The memory 634 may be utilized to store and/or retrieve data and/or PDUs that may be processed by the TOE 641. The memory 634 may store code that may be executed by the TOE 641.

The network interface 632 may comprise suitable logic, circuitry, and/or code that may be utilized to transmit and/or receive PDUs via a network 204. The network interface may be coupled to the network 204. The network interface may be coupled to the bus 636. The network interface 632 may receive bits via the bus 636. The network interface 632 may subsequently transmit the bits via the network 204 that may be contained in a representation of a PDU by converting the bits into electrical and/or optical signals, with timing parameters, and with signal amplitude, energy and/or power levels as specified by an appropriate specification for a network medium, for example, Ethernet. The network interface 632 may also transmit framing information that identifies the start and/or end of a transmitted PDU.

The network interface 632 may receive bits that may be contained in a PDU received via the network 204 by detecting framing bits indicating the start and/or end of the PDU. Between the indication of the start of the PDU and the end of the PDU, the network interface 632 may receive subsequent bits based on detected electrical and/or optical signals, with timing parameters, and with signal amplitude, energy and/or power levels as specified by an appropriate specification for a network medium, for example, Ethernet. The network interface 632 may subsequently transmit the bits via the bus 636.

The processor 643 may comprise suitable logic, circuitry, and/or code that may be utilized to perform at least a portion of the protocol processing tasks within the TOE 641.

The local connection point 645 may comprise a computer program that comprises at least one code section that may be executable by the processor 643 for causing the processor 643 to perform steps comprising protocol processing, for example protocol processing related to the establishment of TCP tunnels, in accordance with an embodiment of the invention.

The local RDMA access point 647 may comprise a computer program that comprises at least one code section that may be executable by the processor 643 for causing the processor 643 to perform steps comprising protocol processing, for example protocol processing related to the establishment of RDMA connection and/or the association of a plurality of RDMA connections with a corresponding one or more TCP tunnels, in accordance with an embodiment of the invention.

The processor 644a may be substantially as described for the processor 614a. The processor 644a may be coupled to the bus 652. The local application 644b may be substantially as described for the local application 614b. The processor 646a may be substantially as described for the processor 614a. The processor 646a may be coupled to the bus 652. The local application 646b may be substantially as described for the local application 614b. The processor 648a may be substantially as described for the processor 614a. The processor 648a may be coupled to the bus 652.

The local application 648b may be substantially as described for the local application 614b. The system memory 650 may be substantially as described for the system memory 620. The system memory 650 may be coupled to the bus 652. The RNIC 642 may be substantially as described for the RNIC 612. The RNIC 642 may be coupled to the bus 652. The TOE 672 may be substantially as described for the TOE 641. The TOE 672 may be coupled to the bus 652. The TOE 672 may be coupled to the bus 666. The network interface 662 may be substantially as described for the network interface 632. The network interface 662 may be coupled to the bus 666. The memory 664 may be substantially as described for the memory 634. The memory 664 may be coupled to the bus 666. The processor 674 may be substantially as described for the processor 643. The remote connection point 676 may be substantially as described for the local connection point 645. The remote RDMA access point 677 may be substantially as described for the local RDMA access point 647.

In operation, one or more local applications 614b, 616b, and/or 618b may attempt to establish a plurality of RDMA connections with one or more remote applications 644b, 646b, and/or 648b. In various embodiments of the invention, a corresponding one or more TCP connections may be established between the local computer system 602, and the remote computer system 606. The TCP connections may be referred to as communication channels. Any of the one or more TCP connections may subsequently be utilized as a tunnel by at least a portion of the plurality of RDMA connections. A single TCP connection may be utilized by a plurality of RDMA connections. The one or more TCP connections may be established prior to attempts to establish a first RDMA connection. The TCP connections may be referred to as being pre-established in this case. Alternatively, the one or more TCP connections may be established when an attempt is made to establish the first among the plurality of RDMA connections. The TCP connections may be referred to as being established on demand in this case. The TCP connection, once established, may remain established even though RDMA connections tunneled via the TCP connection may be established and terminated. An RDMA connection that is established and terminated may subsequently be re-established and may utilize the same TCP connection.

U.S. application Ser. No. ______ (Attorney Docket No. 17036US01) filed on an even date herewith, provides a detailed description of procedures for establishment of a communication channel, utilizing a TCP connection that may be utilized as a tunnel, and is hereby incorporated by reference in its entirety.

A local application 614b may establish an RDMA connection by sending an RDMA connection request message to a remote application 644b. The connection request message may be issued as a result of the local application 614b invoking one or more functions associated with the RDMA API. The function call may receive a plurality of arguments from the local application 614b. At least a portion of the arguments may be communicated to the RDMA local access point 647. The arguments may comprise a requested destination, a wildcard flag, a requested number of RDMA connections to be established as a result of the RDMA request message, and one or more endpoint identifiers. Other arguments that may be contained in the plurality of arguments received by the RDMA API function call may include a remote address, and a remote port. Optionally, there may be a plurality of remote ports and/or local ports specified. The remote port, or one or more remote ports, may identify one or more remote applications to which one or more RDMA connections is being requested from a corresponding one or more local applications. The one or more local applications may be identified based on the supplied one or more local ports.

The requested destination may represent an identifier that may be utilized by the remote application 644b to identify the local application 614b. For example, the requested destination may represent a TCP port associated with the local application 614b. The requested destination may be utilized with a local address associated with the local connection point 645 to deliver an RDMA frame from the remote computer system 606 to the local RDMA access point 647 within the local computer system 602. The local RDMA access point 647 may inspect information contained within the RDMA frame to identify the local application 614b as the destination for the data contained in the RDMA frame. For example, the RDMA access point 647 may inspect a destination endpoint identifier field, and/or a source endpoint identifier field within the RDMA frame.

The requested number of RDMA connections may enable a plurality of RDMA connections from one or more local applications to be established via a single RDMA connection request message. The plurality of RDMA connections may be associated with one or more local applications. For example, the requested number of connections indication may enable the local application 614b to establish a plurality of RDMA connections.

The one or more endpoint identifiers may be equal in number to the number indicated in the requested number of RDMA connections argument. The list of one or more endpoint identifiers may indicate the RDMA endpoints corresponding to each of the requested number of RDMA connections.

The wildcard flag may enable a plurality of RDMA connections to be tunneled within a single RDMA connection. For example, in the absence of a wildcard flag capability, the recipient of the RDMA connection request message may be required to establish a corresponding number of RDMA connections in response to the number of requested RDMA connections indicated in the RDMA connection request message. The wildcard flag, however, may enable the recipient of the RDMA connection request message to establish a single RDMA connection in response to the number of RDMA connections indicated in the RDMA connection request message. The single RDMA connection at the remote computer system 606 may be associated with a single remote RDMA connection endpoint at the remote computer system 606. The single remote RDMA connection endpoint may be associated with the remote application 644b. Consequently, any one of the plurality of local RDMA connection endpoints may send information to the single remote RDMA endpoint. The wildcard flag feature may enable a reduction in the total number of required RDMA connections in a cluster environment than may be the case in the absence of the wildcard flag feature.

The remote address may represent a network address associated with the remote connection point 676. The remote port may identify the remote RDMA access point 677 as the destination for the RDMA connection request message.

The arguments from the RDMA API function call by the local application 614b may be received by the local RDMA access point 647. In the event of a pre-established TCP tunnel, the RDMA access point may utilize the remote address argument to identify a corresponding TCP tunnel that may be utilized to transport the RDMA connection request message across the network 204 to the remote computer system 606. In the event of an on-demand TCP tunnel, the local RDMA access point 647 may issue a request to the local connection point 645 requesting the establishment of a TCP tunnel to the remote connection point 676. Upon establishment of the TCP tunnel, the local connection point 645 may send a connection identifier associated with the TCP tunnel. The local RDMA access point 647 may send at least a portion of the RDMA connection request message, encapsulated in a TCP packet, via the established TCP tunnel.

Upon receipt of the TCP packet via the TCP tunnel, the remote connection point 676 may forward at least a portion of the TCP packet to the remote RDMA access point 677 based on the remote port field in the TCP packet header. Based on information contained in the remote port field, the remote RDMA access point 677 may determine that an RDMA endpoint for the requested RDMA connection is associated with the remote application 644b.

The remote access point 677 may process the RDMA connection request message. If remote access point 677 determines that the remote application 644b may not accept the RDMA connection request from the local application 614b, an RDMA connection reject message may be sent to the local RDMA access point 647. If the remote access point 677 determines that the remote application 644b may accept the RDMA connection request, an RDMA connection accept message may be sent to the local RDMA access point 647.

In forming the RDMA connection accept message the remote application 644b may invoke one or more functions associated with the RDMA API. The function call may receive a plurality of arguments from the remote application 644b. At least a portion of the arguments may be communicated to the RDMA remote access point 677. The arguments may comprise one or more endpoint identifier pairings, one or more local ports, and/or one or more remote ports. The one or more local ports and/or one or more remote ports may be as indicated in the received RDMA connection request message. The one or more endpoint pairings may comprise a listing indicating, for each requested RDMA connection, the local and remote RDMA endpoints. The number of endpoint pairing may correspond to the requested number of RDMA connections in the RDMA connection request message. Each local RDMA endpoint in the one or more pairing may be as specified in the corresponding one or more endpoint identifiers in the RDMA connection request message. Each remote RDMA endpoint may be as specified by the one or more remote applications identified based on the one or more remote ports identified in the received RDMA connection request message.

Based on the information received from the remote application 644b, or one or more remote applications, via the RDMA API function invocations, the remote RDMA access point 677 may communicate the RDMA connection accept or RDMA connection reject message within an RDMA frame. At least a portion of the RDMA frame may be encapsulated within a TCP packet by the remote connection point 676 and sent to the local connection point 645 via the established TCP tunnel. The local connection point 645 may send at least a portion of the de-encapsulated RDMA frame to the local RDMA access point 647. The local RDMA access point 647 may send at least a portion of an ULP PDU, which was de-encapsulated from the received RDMA frame to the local application 614b. At this point one or more RDMA connections may be established between at least the local application 614b and at least the remote application 644b. Subsequent exchanges of information via the one or more RDMA connections may be transported across the network 204 via the one or more corresponding established TCP tunnels.

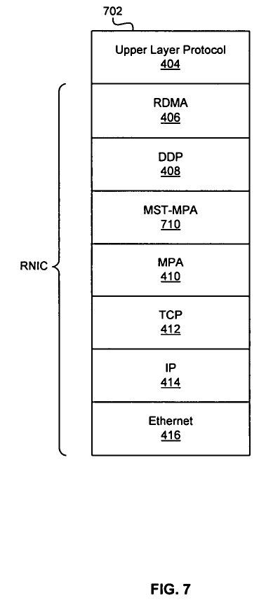

FIG. 7 is an illustration of an exemplary RDMA over TCP protocol stack utilizing MST-MPA, in accordance with an embodiment of the invention. Referring to FIG. 7, there is shown a conventional RDMA over TCP protocol stack 402. The RDMA over TCP protocol stack 402 may comprise an upper layer protocol 404, an RDMA protocol 406, a direct data placement protocol (DDP) 408, an MST-MPA protocol 710, a marker-based PDU aligned protocol (MPA) 410, a TCP 412, an IP 414, and an Ethernet protocol 416. An RNIC may comprise functionality associated with the RDMA protocol 406, DDP 408, MPA protocol 410, TCP 412, IP 414, and Ethernet protocol 416.

The MST-MPA protocol 710 methods that enable frames in a plurality of RDMA connections to be transported, via the network 204, via a TCP tunnel. The MST-MPA protocol 710 may embed information within at least a portion of the RDMA frame. The embedded information may allow RDMA frames from a plurality of RDMA connection to be multiplexed into a single TCP tunnel such that the receiving RDMA access point may be able to identify a distinct RDMA connection associated with each of the RDMA frames that were tunneled in a single TCP connection. The TCP connection may represent a communication channel between a local computer system 602 and a remote computer system 606 in a cluster environment.

The information embedded by the MST-MPA protocol 710 may comprise a source endpoint identifier, a destination endpoint identifier, and/or a source sequence number. The source endpoint identifier may identify a local RDMA endpoint that may send information contained in the RDMA frame. The destination endpoint identifier may identify a remote RDMA endpoint that may receive the information sent by the local RDMA endpoint. The source sequence number may indicate an ordinal relationship between RDMA frames sent from the local RDMA endpoint and the remote RDMA endpoint via the established RDMA connection.

The MST-MPA protocol 710 may present a lower layer protocol interface compatible with the DDP 408. For example, the MST-MPA protocol 710 may present an interface to the DDP 408 which may be substantially equivalent to the interface presented to the DDP 408 by the MPA protocol 408. The MST-MPA protocol 710 may present an upper layer protocol interface compatible with the MPA protocol 410. For example, the MST-MPA protocol 710 may present an interface to the MPA protocol 410 which may be substantially equivalent to the interface presented to the MPA protocol 410 by the DDP 408.

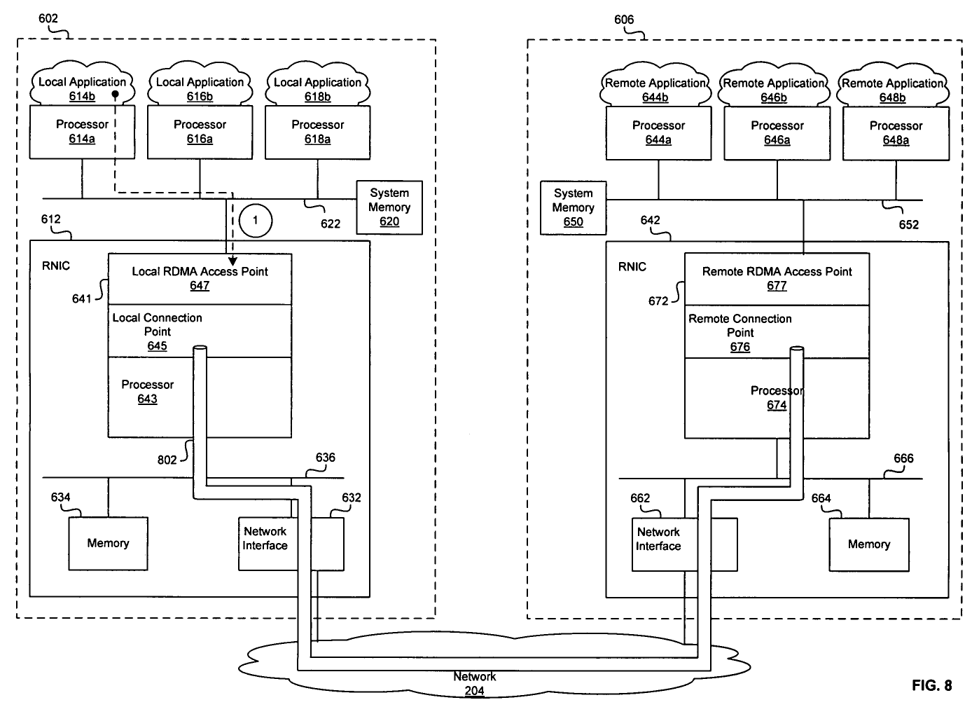

FIG. 8 is a block diagram illustrating an exemplary transfer of information between a local application and a local RDMA access point, in accordance with an embodiment of the invention. Referring to FIG. 8, there is shown a network 204, and a local computer system 602, a remote computer system 606, and an established communication channel 802. The local computer system 602 may comprise an RDMA-enabled network interface card (RNIC) 612, a plurality of processors 614a, 616a and 618a, a plurality of local applications 614b, 616b, and 618b, a system memory 620, and a bus 622. The RNIC 612 may comprise a TCP offload engine (TOE) 641, a memory 634, a network interface 632, and a bus 636. The TOE 641 may comprise a processor 643, a local connection point 645, and a local RDMA access point 647. The remote computer system 606 may comprise a RNIC 642, a plurality of processors 644a, 646a, and 648a, a plurality of remote applications 644b, 646b, and 648b, a system memory 650, and a bus 652. The RNIC 642 may comprise a TOE 672, a memory 664, a network interface 662, and a bus 666. The TOE 672 may comprise a processor 674, a remote connection point 676, and a remote RDMA access point. The established communication channel 802 may comprise a TCP tunnel.

FIG. 8 comprises an annotation of FIG. 6 to illustrate the path of an ULP PDU transmitted by the local application 614b to the local RDMA access point 647 via the bus 622. The path, segment 1, is indicated in FIG. 8 by reference number “1.” The ULP PDU may be communicated from the local application 614b to the local RDMA access point 647 as a result of one or more RDMA API function calls. The ULP PDU may be one of a plurality arguments passed in the API function calls. The local application 614b may comprise a local RDMA connection endpoint in the corresponding RDMA connection. The remote application 644b may comprise a remote RDMA connection endpoint in the RDMA connection. The remote application 644b may be the recipient of the ULP PDU.

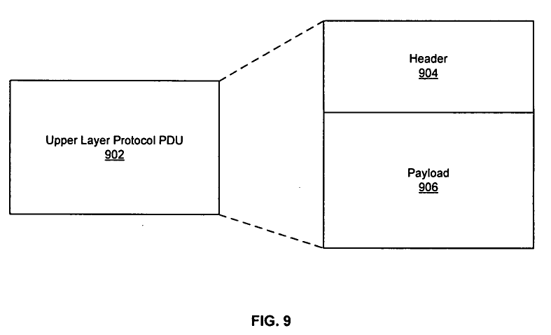

FIG. 9 is a block diagram of an exemplary ULP PDU, in accordance with an embodiment of the invention. Referring to FIG. 9, there is shown a ULP PDU 902. The ULP PDU 902 may comprise a ULP header 904, and a ULP payload 906. The ULP payload 906 may comprise data being transferred from a local application user space 222 to a remote application user space 252. The ULP header 904 may comprise information that identifies an instance of the local application.

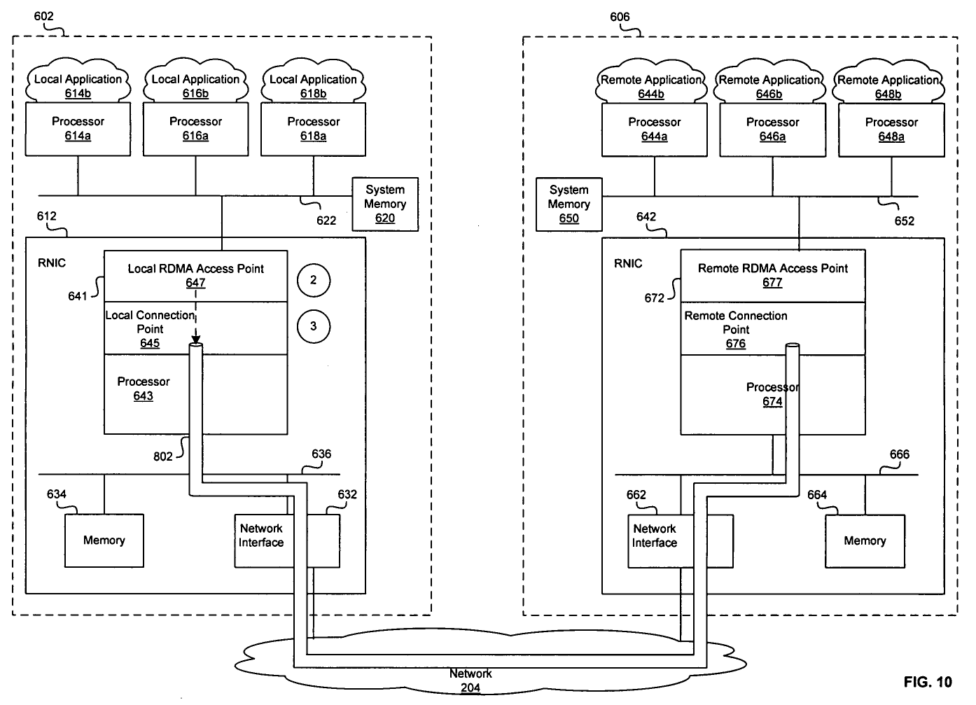

FIG. 10 is a block diagram of an exemplary tunneling of information in an RDMA connection via a communication channel, in accordance with an embodiment of the invention. Referring to FIG. 10, there is shown a network 204, and a local computer system 602, a remote computer system 606, and an established communication channel 802. The local computer system 602 may comprise an RDMA-enabled network interface card (RNIC) 612, a plurality of processors 614a, 616a and 618a, a plurality of local applications 614b, 616b, and 618b, a system memory 620, and a bus 622. The RNIC 612 may comprise a TCP offload engine (TOE) 641, a memory 634, a network interface 632, and a bus 636. The TOE 641 may comprise a processor 643, a local connection point 645, and a local RDMA access point 647. The remote computer system 606 may comprise a RNIC 642, a plurality of processors 644a, 646a, and 648a, a plurality of remote applications 644b, 646b, and 648b, a system memory 650, and a bus 652. The RNIC 642 may comprise a TOE 672, a memory 664, a network interface 662, and a bus 666. The TOE 672 may comprise a processor 674, a remote connection point 676, and a remote RDMA access point.

FIG. 10 comprises an annotation of FIG. 6 to illustrate the tunneling of an RDMA connection within a communication channel 802. The path comprises segments 2 and 3. Segment 2, is indicated in FIG. 10 by reference number “2.” Segment 3, is indicated in FIG. 10 by reference number “3.” At the segment 2, at least a portion of the ULP PDU may be encapsulated in an RDMA frame. The at least a portion of the UPL PDU may comprise a DDP segment. At the segment 3, an MST-MPA protocol message may be encapsulated in a TCP packet.

Based on information received via the RDMA API function call, the local RDMA access point 647 may identify the RDMA connection, and identify the corresponding TCP tunnel associated with the RDMA connection. This information may be passed from the local RDMA access point 647 to the local connection point 645. The local connection point 645 may select one of a plurality of TCP tunnels and send the TCP packet via the selected TCP tunnel.

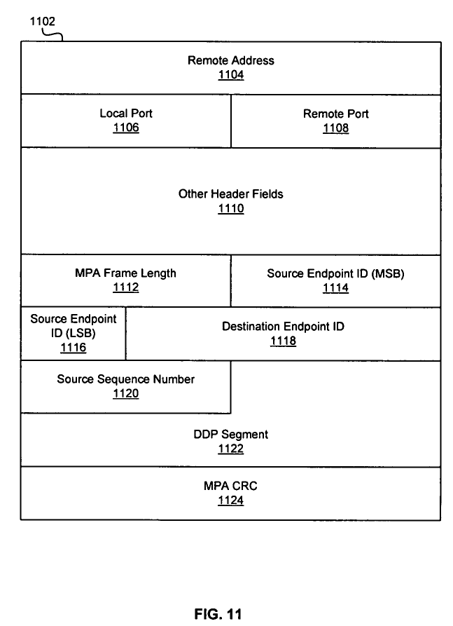

FIG. 11 is a block diagram of an exemplary MST-MPA protocol message, in accordance with an embodiment of the invention. Referring to FIG. 11, there is shown an MST-MPA protocol message 1102. The MST-MPA protocol message 1102 may comprise a remote address field 1104, a local port field 1106, a remote port field 1108, other header fields 1110, an MPA frame length field 1112, a most significant bits in a source endpoint identifier field 1114, a least significant bits in a source endpoint identifier field 1116, a destination endpoint identifier field 1118, a source sequence number field 1120, a DDP segment field 1122, and an MPA cyclical redundancy check (CRC) field 1124. The remote address 1104, local port 1106, remote port 1108, and other header fields 1110, may comprise header information associated with the MST-MPA protocol message 1102. The header fields may be passed as arguments via the RDMA API. The MPA frame length 1112, source endpoint identifier fields 1114 and 1116, destination endpoint identifier 1118, source sequence number 1120, DDP segment 1122, and MPA CRC 1124 fields may comprise a payload.

The remote address field 1104 may represent a network address associated with a remote connection point 676. The local port field 1106 may identify a local application that sent information contained within the MST-MPA protocol message 1102. The remote port field 1108 may identify a remote application that is to receive the information contained within the MST-MPA protocol message 1102. The other header fields 1110 may be utilized in connection with protocol processing.

The MPA frame length 1112 may indicate the length of the payload. The source endpoint identifier fields 1114 and 1116 may identify the local RDMA endpoint in the RDMA connection. The destination endpoint identifier field 1118 may identify the remote RDMA endpoint in the RDMA connection. The source sequence number field 1120 may indicate an ordinal relationship between MST-MPA protocol messages sent from the local RDMA endpoint and the remote RDMA endpoint via the established RDMA connection. MST-MPA protocol messages may be sequentially numbered according to the order in which they were sent by the local application 614b.

The DDP segment 1122 may comprise at least a portion of the ULP PDU 902. If an ULP PDU is divided among a plurality of DDP segments 1122, a unique and sequential source sequence number 1120 may identify each DDP segment 1122. The MPA CRC 1124 may comprise information utilized by the remote RDMA access point 677 to check for errors in the received MST-MPA protocol message 1102.

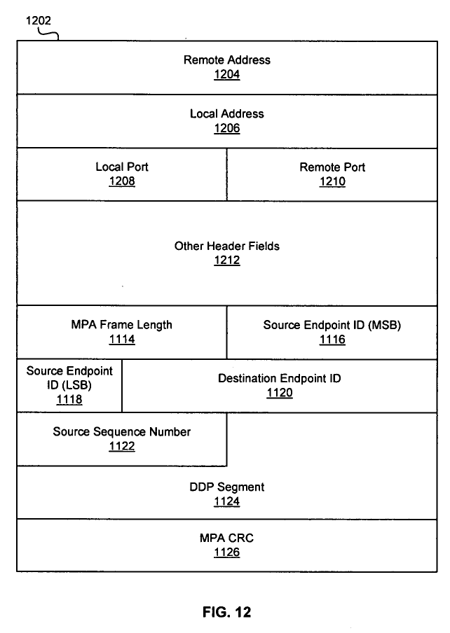

FIG. 12 is a block diagram of an exemplary TCP packet, in accordance with an embodiment of the invention. Referring to FIG. 12, there is shown a TCP packet 1202. The TCP packet 1202 may comprise a remote address field 1204, a local address field 1206, a local port field 1208, a remote port field 1210, other header fields 1212, an MPA frame length field 1112, a most significant bits in a source endpoint identifier field 1114, a least significant bits in a source endpoint identifier field 1116, a destination endpoint identifier field 1118, a source sequence number field 1120, a DDP segment field 1122, and an MPA CRC field 1124.

The remote address field 1204 may represent a network address associated with a remote connection point 676. The local address field 1206 may represent a network address associated with a local connection point 645. The local port field 1208 may identify a local application that sent information contained within the TCP packet 1202. The remote port field 1210 may identify a remote application that is to receive the information contained within the TCP packet 1202. The other header fields 1212 may be utilized in connection with protocol processing in accordance with the TCP as specified by the applicable IETF specifications.

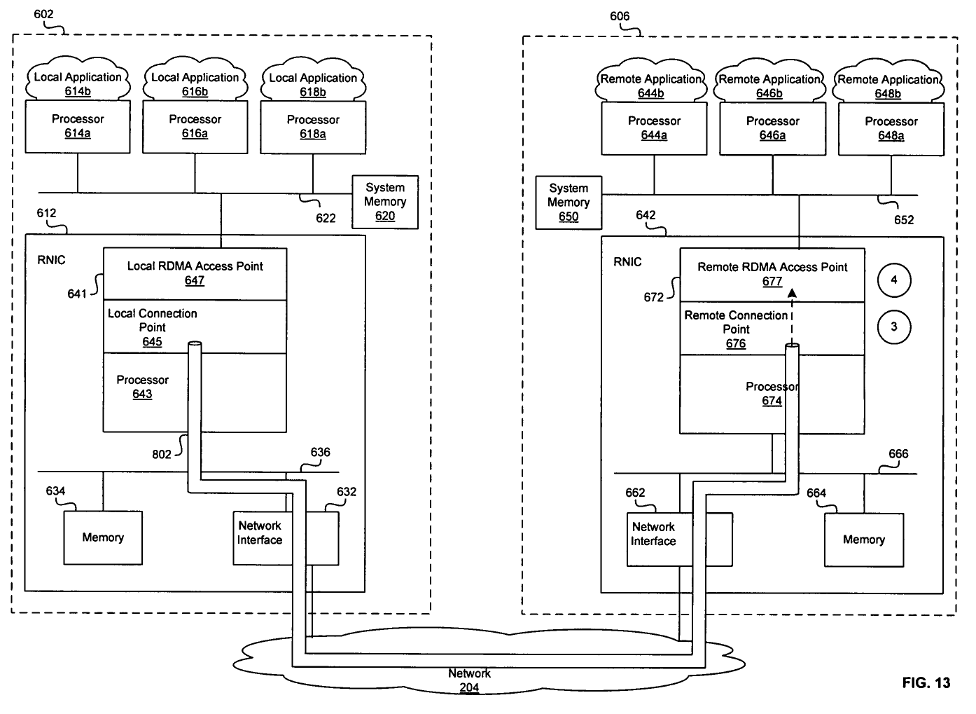

FIG. 13 is a block diagram illustrating an exemplary retrieval of an RDMA connection tunneled via a communication channel, in accordance with an embodiment of the invention. Referring to FIG. 13, there is shown a network 204, and a local computer system 602, a remote computer system 606, and an established communication channel 802. The local computer system 602 may comprise an RDMA-enabled network interface card (RNIC) 612, a plurality of processors 614a, 616a and 618a, a plurality of local applications 614b, 616b, and 618b, a system memory 620, and a bus 622. The RNIC 612 may comprise a TCP offload engine (TOE) 641, a memory 634, a network interface 632, and a bus 636. The TOE 641 may comprise a processor 643, a local connection point 645, and a local RDMA access point 647. The remote computer system 606 may comprise a RNIC 642, a plurality of processors 644a, 646a, and 648a, a plurality of remote applications 644b, 646b, and 648b, a system memory 650, and a bus 652. The RNIC 642 may comprise a TOE 672, a memory 664, a network interface 662, and a bus 666. The TOE 672 may comprise a processor 674, a remote connection point 676, and a remote RDMA access point.

FIG. 13 comprises an annotation of FIG. 6 that illustrates the tunneling of an RDMA connection within a communication channel 802. The path comprises segments 3 and 4. Segment 3, is indicated in FIG. 13 by reference number “3.” Segment 4, is indicated in FIG. 13 by reference number “4. ” The segment 3, may represent receipt, by the remote connection point 676, of the TCP packet communicated by the local connection point 645 via the TCP tunnel 802. The remote connection point 676 may perform protocol processing including validation of header fields and/or error detection and/or correction of the received TCP packet. The remote connection point 676 may utilize information in the TCP packet header, for example the remote port field, to determine that the information contained in the TCP packet is to be delivered to the remote RDMA access point 677. At the segment 4, the remote connection point 676 may deliver a de-encapsulated MST-MPA protocol message, or portion thereof, to the remote RDMA access point 677. Based on information contained in the MST-MPA protocol message, the remote RDMA access point 677 may identify the remote application 644b as the destination for information contained in the MST-MPA protocol message.

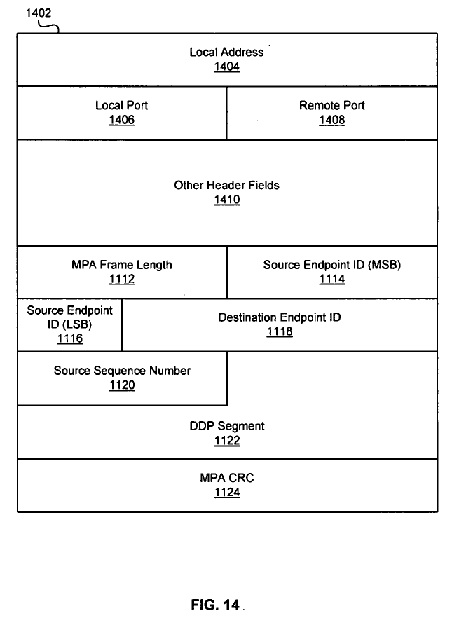

FIG. 14 is a block diagram of an exemplary received MST-MPA protocol message, in accordance with an embodiment of the invention. Referring to FIG. 14, there is shown an MST-MPA protocol message 1402. The MST-MPA protocol message 1402 may comprise a local address field 1404, a local port field 1406, a remote port field 1408, other header fields 1410, an MPA frame length field 1112, a most significant bits in a source endpoint identifier field 1114, a least significant bits in a source endpoint identifier field 1116, a destination endpoint identifier field 1118, a source sequence number field 1120, a DDP segment field 1122, and an MPA cyclical redundancy check (CRC) field 1124. The local address 1404, local port 1406, remote port 1408, and other header fields 1410, may comprise header information associated with the MST-MPA protocol message.

The local address field 1404 may represent a network address associated with a local connection point 645. The local port field 1406 may identify an application, for example the local application 614b, which sent information contained within the MST-MPA protocol message 1402. The remote port field 1408 may identify an application, for example the remote application 644b, which is to receive the information contained within the MST-MPA protocol message 1402. The other header fields 1410 may be utilized in connection with protocol processing.

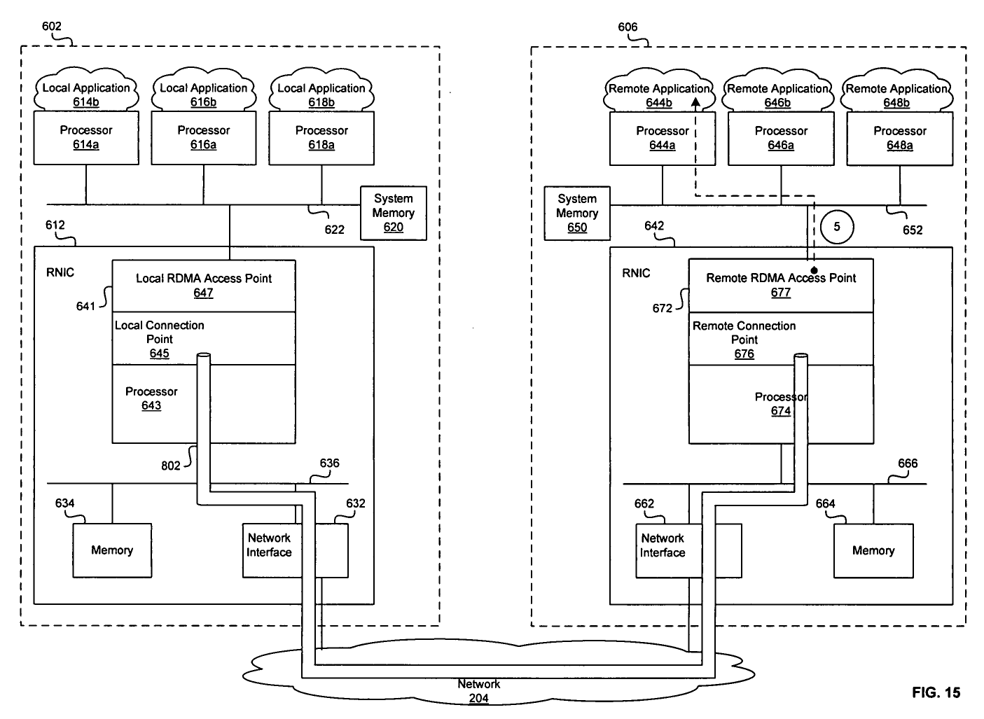

FIG. 15 is a block diagram illustrating an exemplary transfer of information between a remote RDMA access point and a remote application, in accordance with an embodiment of the invention. Referring to FIG. 15, there is shown a network 204, and a local computer system 602, a remote computer system 606, and an established communication channel 802. The local computer system 602 may comprise an RDMA-enabled network interface card (RNIC) 612, a plurality of processors 614a, 616a and 618a, a plurality of local applications 614b, 616b, and 618b, a system memory 620, and a bus 622. The RNIC 612 may comprise a TCP offload engine (TOE) 641, a memory 634, a network interface 632, and a bus 636. The TOE 641 may comprise a processor 643, a local connection point 645, and a local RDMA access point 647. The remote computer system 606 may comprise a RNIC 642, a plurality of processors 644a, 646a, and 648a, a plurality of remote applications 644b, 646b, and 648b, a system memory 650, and a bus 652. The RNIC 642 may comprise a TOE 672, a memory 664, a network interface 662, and a bus 666. The TOE 672 may comprise a processor 674, a remote connection point 676, and a remote RDMA access point. The established communication channel 802 may comprise a TCP tunnel.

FIG. 15 comprises an annotation of FIG. 6 to illustrate the path of an ULP PDU transmitted by the remote RDMA access point 676 to the local application 614b via the bus 652. The path, segment 5, is indicated in FIG. 15 by reference number “5.” The segment 5 may deliver the ULP PDU 902 to the remote application 644b. The ULP PDU may be communicated from the remote RDMA access point 677 to the remote application 644b as a result of one or more RDMA API function calls. The ULP PDU 902 may be one of a plurality arguments passed in the API function calls. The remote application 644b may comprise the remote RDMA connection endpoint that may be the recipient of the ULP PDU 902.

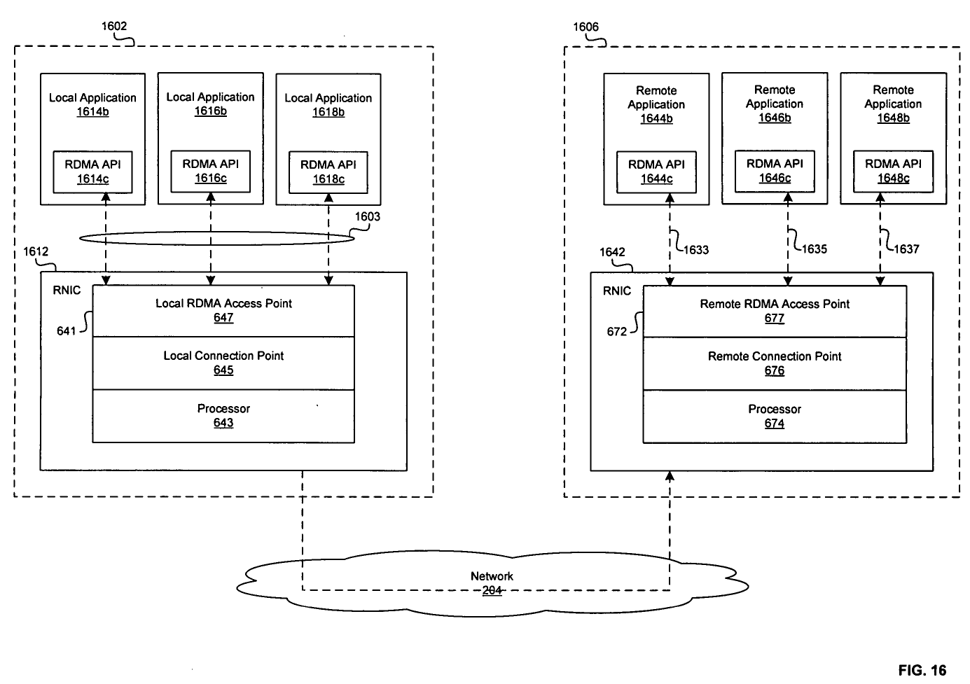

FIG. 16 is a block diagram illustrating exemplary tunneling of RDMA connections within an RDMA connection, in accordance with an embodiment of the invention. Referring to FIG. 16, there is shown a network 204, and a local computer system 1602, and a remote computer system 1606. The local computer system 1602 may comprise an RNIC 1612, and a plurality of local applications 1614b, 1616b, and 1618b. The local application 1614b may comprise an RDMA API interface 1614c. The local application 1616b may comprise an RDMA API interface 1616c. The local application 1618b may comprise an RDMA API interface 1618c. The RNIC 1612 may comprise a TOE 1641. The TOE 641 may comprise a processor 643, a local connection point 645, and a local RDMA access point 647. The remote computer system 1606 may comprise a RNIC 1642, and a plurality of remote applications 1644b, 1646b, and 1648b. The remote application 1644b may comprise an RDMA API interface 1644c. The remote application 1646b may comprise an RDMA API interface 1646c. The remote application 1648b may comprise an RDMA API interface 1648c. The RNIC 1642 may comprise a TOE 672. The TOE 672 may comprise a processor 674, a remote connection point 676, and a remote RDMA access point. A plurality of RDMA connections 1603, and individual RDMA connections 1633, 1635, and 1637 are also shown.

The plurality of RDMA connections 1603 may represent the RDMA connection from each of the local applications 1614b, 1616b, and 1618b to the local RDMA access point 647. The RDMA connection 1633 may represent the RDMA connection from the remote application 1644b to the remote RDMA access point 677. The RDMA connection 1635 may represent the RDMA connection from the remote application 1646b to the remote RDMA access point 677. The RDMA connection 1637 may represent the RDMA connection from the remote application 1648b to the remote RDMA access point 677.

The RNIC 1612 may be substantially as described for the RNIC 612. The RNIC 1642 may be substantially as described for the RNIC 642. The local application 1614b may be substantially as described for the local application 614b. The local application 1616b may be substantially as described for the local application 616b. The local application 1618b may be substantially as described for the local application 618b. The remote application 1644b may be substantially as described for the remote application 644b.

The RDMA API interface 1614c may comprise a plurality of function calls that may enable the local application 1614b to utilize the services of the RDMA protocol. For example, the local application 1614b may utilize the RDMA API interface 1614c to issue an RDMA read and/or RDMA write instruction to a peer application within a cluster environment. The RDMA API interface 1616c may be substantially as described for the RDMA API interface 1614c. The RDMA API interface 1618c may be substantially as described for the RDMA API interface 1614c. The RDMA API interface 1644c may be substantially as described for the RDMA API interface 1614c.

When a plurality of local applications 1614b, 1616b, and 1618b utilize the wildcard flag when establishing an RDMA connection to the remote application 1644b, RDMA frames transmitted via any of the plurality of RDMA connections 1603 among the local applications 1614b, 1616b, and 1618b, referred to by distinct endpoint identifiers in the RDMA frame, may be delivered to the remote application 1644b via the single RDMA connection 1633. When a plurality of local applications 1614b, 1616b, and 1618b utilize the wildcard flag when establishing an RDMA connection to the remote application 1646b, RDMA frames transmitted via any of the plurality of RDMA connections 1603 among the local applications 1614b, 1616b, and 1618b may be delivered to the remote application 1644b via the single RDMA connection 1635.

When a plurality of local applications 1614b, 1616b, and 1618b utilize the wildcard flag when establishing an RDMA connection to the remote application 1648b, RDMA frames transmitted via any of the plurality of RDMA connections 1603 among the local applications 1614b, 1616b, and 1618b may be delivered to the remote application 1648b via the single RDMA connection 1637. The utilization of the wildcard flag when establishing RDMA connections in the exemplary system illustrated in FIG. 16 may result in a reduction in the number of RDMA connections required to enable any of the local applications 1614b, 1616b, and 1618b to communicate with any of the remote applications 1644b, 1646b, and 1648b. For example, with the utilization of the wildcard flag, a total of 9 RDMA connections may be required. By utilizing the wildcard flag, a total of 6 RDMA connections may be required.

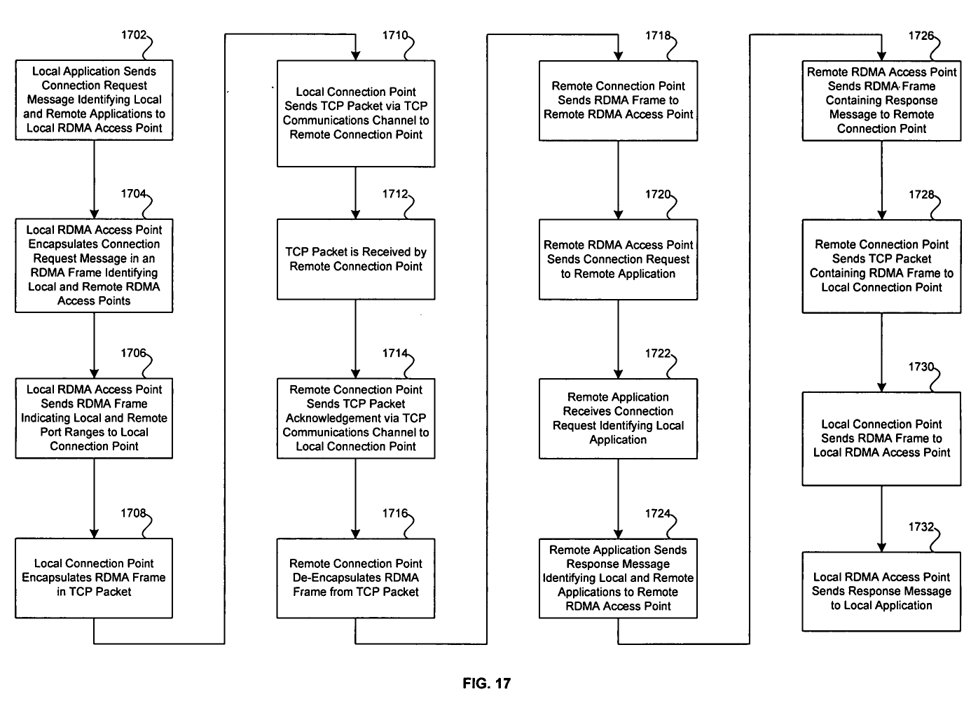

FIG. 17 is a flowchart illustrating exemplary steps for an MST-MPA protocol, in accordance with an embodiment of the invention. Referring to FIG. 17, in step 1702 a local application 614b may send an RDMA connection request message to the local RDMA access point 647. The RDMA connection request message may identify the local application 614b and remote application 644b that may communicate via the requested RDMA connection. In step 1704, the local RDMA access point 647 may encapsulate at least a portion of the RDMA connection request message in an RDMA frame. The RDMA frame may identify the local RDMA access point 647 and the remote RDMA access point 677. In step 1706, the local RDMA access point 647 may send an RDMA frame to the local connection point 645. The RDMA frame may indicate a range of local ports and/or remote ports that may be associated with one or more RDMA connections that may be established.

In step 1708, the local connection point 645 may encapsulate at least a portion of the RDMA frame in a TCP packet. In step 1710, the local connection point 645 may send the TCP packet, via an established TCP communications channel, to the remote connection point 676. The TCP communications channel may function as a TCP tunnel that transports information across a network 204. In step 1712, the TCP packet may be received by the remote connection point 676. In step 1714, the remote connection point 676 may send a TCP packet to the local connection point 645 to acknowledge receipt of the TCP packet containing the RDMA connection request message. In step 1716, the remote connection point 676 may de-encapsulate at least a portion of the RDMA frame from the TCP packet. In step 1718, the remote connection point 676 may send the RDMA frame to the remote RDMA access point 677. In step 1720, the remote RDMA access point 677 may send the RDMA connection request message to the remote application 644b. In step 1722, the remote application 644b may receive the RDMA connection request message. The remote application 644b may receive information identifying the local application 614b that may request establishment of the RDMA connection.

In step 1724, the remote application 644b may send a response message to the remote RDMA access point 677. The response message may be an RDMA connection accept message. The response message may also indicate the local application 614b and remote application 644b that may be paired via the RDMA connection. In step 1726, the remote RDMA access point 677 may send an RDMA frame containing the response message to the remote connection point 676. In step 1728, the remote connection point 676 may send a TCP packet containing the RDMA frame to the local connection point 645 via the established TCP tunnel. In step 1730, the local connection point 645 may send the RDMA frame to the local RDMA access point 647. In step 1732, the local RDMA access point 647 may send the response message to the local application 614b.

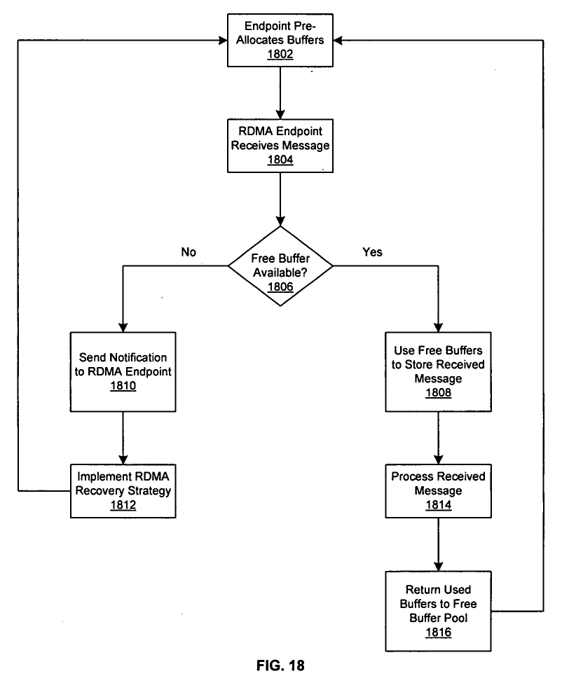

FIG. 18 is a flowchart illustrating an exemplary process for buffer management at an RDMA endpoint, in accordance with an embodiment of the invention. In various embodiments of the invention, an RDMA endpoint may allocate a portion of system memory 650. A remote application 1644b may instantiate an RDMA endpoint through the execution of function calls based on an RDMA API 1644c, for example. The allocated portion of the system memory 650 may be utilized to provide one or more buffers to store one or more received messages. In step 1802, an RDMA endpoint may pre-allocate buffers. An application may enact the pre-allocation of buffers by performing RDMA API function calls, for example. The pre-allocated buffers may be associated with a port identifier, for example a local port, that is associated with the RDMA endpoint. The pre-allocated buffers may form a free buffer pool. In step 1804, a message may be received by the RDMA endpoint. Step 1806 may determine if there is a sufficient quantity of buffers remaining in the free buffer pool to store the received message. The number of buffers utilized to store the received message may depend upon the size of the message, as measured in bytes for example. If there is a sufficient number of buffers to receive the message, in step 1808, the RDMA endpoint may utilize a portion of the free buffer pool to store the received datagram. For example, the RDMA endpoint associated with the remote application 644b may utilize a portion of a free buffer pool to store a message received via segment 5 (FIG. 15). A utilized buffer may be removed from the free buffer pool. This may reduce the number of buffers remaining in the free buffer pool.

If there is not a sufficient number of buffers to receive the message as determined in step 1806, in step 1810, a notification may be sent to the RDMA endpoint via the RDMA API. The notification may indicate that there was an insufficient number of buffers in the free buffer pool. The notification may be generated by the operating system or execution environment in which the RDMA endpoint is executing. Examples of operating systems may include Unix, and Linux. In step 1812, the RDMA endpoint may implement a recovery strategy in accordance with applicable IETF RDMA protocol specifications, for example.

In step 1814, following step 1808, the RDMA endpoint may process the received message. In step 1816, the RDMA endpoint may return the buffers utilized by the message to the free buffer pool. This may increase the number of buffers remaining the free buffer pool. Step 1804 may follow step 1812 or step 1816.

Aspects of a system for transporting information via a communications system may include a processor 643 that enables establishing from a local remote direct memory access (RDMA) enabled network interface card (RNIC) at least one communication channel, based on the transmission control protocol (TCP), between the local RNIC 612 and at least one remote RNIC 642 via at least one network 604. The processor 643 may enable establishing at least one RDMA connection between one of a plurality of local RDMA endpoints and at least one remote RDMA endpoint utilizing the communication channels. The processor 643 may further enable communicating messages of via the established RDMA connections between one of the plurality of local RDMA endpoints and at least one remote RDMA endpoint, independent of whether the messages are in-sequence or out-of-sequence.

In another aspect of the invention, the processor 643 may enable receiving, via the RDMA connections at the local RNIC 612, a connection request message including a requested destination and/or at least one remote endpoint identifier. The requested destination may be a remote port associated with a TCP connection. The at least one remote endpoint identifier may have a value that is greater than 0. The processor 643 may enable selecting one of the communication channels as specified by the one of a plurality of local RDMA endpoints. A connection response message may be communicated from one of the plurality of RDMA endpoints to one or more of the remote RDMA endpoints. The connection response message may include an active port, a passive port, and/or a pairing that may include a local endpoint identifier and/or a remote endpoint identifier. The pairing may correspond to a tuple that includes a local address, a remote address, an active port, and/or a passive port. The connection response message may be a connection accept message and/or a connection reject message. The processor 643 may enable terminating at least one RDMA connection without terminating the corresponding at least one communication channel.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for transporting information via a communications system, the method comprising:
establishing at least one TCP communication channel between a local remote direct memory access (RDMA) enabled network interface card (RNIC) and at least one remote RNIC via at least one network;
establishing RDMA connections between one of a plurality of local RDMA endpoints and at least one remote RDMA endpoint utilizing said established at least one TCP communication channel;
communicating messages via said established RDMA connections between said one of said plurality of local RDMA endpoints and said at least one remote RDMA endpoint independent of whether said messages are in-sequence or out-of-sequence.

2. The method according to claim 1, further comprising receiving via said RDMA connections at said local RNIC, a connection request message comprising at least one of the following: a requested destination, and at least one remote endpoint identifier.

3. The method according to claim 2, wherein said requested destination is a remote port.

4. The method according to claim 2, wherein said at least one remote endpoint identifier comprises a value that is greater than 0.

5. The method according to claim 1, further comprising selecting one of said at least one TCP communication channel as specified by said one of a plurality of local RDMA endpoints.

6. The method according to claim 1, further comprising communicating a connection response message from said one of said plurality of local RDMA endpoints to said at least one remote RDMA endpoint.

7. The method according to claim 6, wherein said connection response message comprises at least one of the following: an active port, a passive port, and a pairing comprising a local endpoint identifier and a remote endpoint identifier.

8. The method according to claim 7, wherein said pairing corresponds to a tuple comprising at least one of the following: a local address, a remote address, an active port, and a passive port.

9. The method according to claim 6, wherein said connection response message is one of the following: a connection accept message and a connection reject message.

10. The method according to claim 1, further comprising terminating said at least one RDMA connection without terminating said at least one TCP communication channel.

11. A machine-readable storage having stored thereon, a computer program having at least one code section for enabling transporting of information via a communications system, the at least one code section being executable by a machine for causing the machine to perform steps comprising:
establishing at least one TCP communication channel between a local remote direct memory access (RDMA) enabled network interface card (RNIC) and at least one remote RNIC via at least one network;
establishing RDMA connections between one of a plurality of local RDMA endpoints and at least one remote RDMA endpoint utilizing said established at least one TCP communication channel;
communicating messages via said established RDMA connections between said one of said plurality of local RDMA endpoints and said at least one remote RDMA endpoint independent of whether said messages are in-sequence or out-of-sequence.

12. The machine-readable storage according to claim 11, further comprising code for receiving via said RDMA connections at said local RNIC, a connection request message comprising at least one of the following: a requested destination, and at least one remote endpoint identifier.

13. The machine-readable storage according to claim 12, wherein said requested destination is a remote port.

14. The machine-readable storage according to claim 12, wherein said at least one remote endpoint identifier comprises a value that is greater than 0.

15. The machine-readable storage according to claim 11, further comprising code for selecting one of said at least one TCP communication channel as specified by said one of a plurality of local RDMA endpoints.

16. The machine-readable storage according to claim 11, further comprising code for communicating a connection response message from said one of said plurality of local RDMA endpoints to said at least one remote RDMA endpoint.

17. The machine-readable storage according to claim 16, wherein said connection response message comprises at least one of the following: an active port, a passive port, and a pairing comprising a local endpoint identifier and a remote endpoint identifier.

18. The machine-readable storage according to claim 17, wherein said pairing corresponds to a tuple comprising at least one of the following: a local address, a remote address, an active port, and a passive port.

19. The machine-readable storage according to claim 16, wherein said connection response message is one of the following: a connection accept message and a connection reject message.

20. The machine-readable storage according to claim 11, further comprising code for terminating said at least one RDMA connection without terminating said at least one TCP communication channel.

21. A system for transporting information via a communications system, the system comprising:
a processor that enables establishing at least one TCP communication channel between a local remote direct memory access (RDMA) enabled network interface card (RNIC) and at least one remote RNIC via at least one network;
said processor enables establishing at least one RDMA connection between one of a plurality of local RDMA endpoints and at least one remote RDMA endpoint utilizing said at least one TCP communication channel;
said processor enables communicating messages via said established RDMA connections between said one of said plurality of local RDMA endpoints and said at least one remote RDMA endpoint independent of whether said messages are in-sequence or out-of-sequence.

22. The system according to claim 21, wherein said processor enables receiving via said RDMA connections at said local RNIC, a connection request message comprising at least one of the following: a requested destination, and at least one remote endpoint identifier.

23. The system according to claim 22, wherein said requested destination is a remote port.

24. The system according to claim 22, wherein said at least one remote endpoint identifier comprises a value that is greater than 0.

25. The system according to claim 21, wherein said processor enables selecting one of said at least one TCP communication channel as specified by said one of a plurality of local RDMA endpoints.

26. The system according to claim 21, wherein said processor enables communicating a connection response message from said one of said plurality of local RDMA endpoints to said at least one remote RDMA endpoint.

27. The system according to claim 26, wherein said connection response message comprises at least one of the following: an active port, a passive port, and a pairing comprising a local endpoint identifier and a remote endpoint identifier.

28. The system according to claim 27, wherein said pairing corresponds to a tuple comprising at least one of the following: a local address, a remote address, an active port, and a passive port.

29. The system according to claim 26, wherein said connection response message is one of the following: a connection accept message and a connection reject message.

30. The system according to claim 21, wherein said processor enables terminating said at least one RDMA connection without terminating said at least one TCP communication channel.
